(19) United States
(12) Patent Application Publication
(10) Pub. No.: US 2007/0048090 A1
(43) Pub. Date: Mar. 1, 2007

(54) Method and apparatus for installation of underground ducts

(76) Inventors: Steven W. Wentworth, Brookfield, WI (US); Robert F. Crane, Oconomowoc, WI (US)

Correspondence Address: Philip G. Meyers;Philip G. Meyers Law Office, Suite 300, 1009 Long Prairie Road, Flower Mound, TX, 75022, US

(21) Appl. No.: 11/216,688

(22) Filed: Aug. 31, 2005

(51) Int. Cl. F16L 1/00

(52) U.S. Cl. 405/184.1; 405/174

(57) ABSTRACT

A cyclic cable pulling machine includes a reaction plate having a flat front face, a frame secured to the reaction plate and a cable pulling mechanism including a hydraulic cylinder and a cable gripping mechanism, the cable gripping mechanism having jaws positioned to engage the cable during a pulling stroke, the hydraulic cylinder having an end abutting the reaction plate and an opposite end secured to the cable gripping mechanism for movement of the cable gripping mechanism away from the reaction plate during a pulling stroke and a powered clamping device attached to the frame which holds the cable during return movement of the cable pulling mechanism.

### TECHNICAL FIELD

The invention relates to underground pipe installation, particularly to methods and systems for installing ducts for fiber optic cables in the ground.

### BACKGROUND OF THE INVENTION

Installation of fiber optic duct work throughout the U.S. to service the telecommunications market is an enormous undertaking. Connecting substantially all residential and commercial buildings with fiber optic cables may require as much if not more footage of duct than is currently laid in the form of buried coaxial (cable TV) conductors. The commercial opportunities for the owners of fiber optic networks is enormous; however, the return on investment in the highly competitive climate of telecom/cable provider/DSL provider makes large capital investments a risky undertaking. For this reason, the rates that investors are willing to pay for installation of the underground duct work required to run fiber optic cables are low. However, while the rates are low, the quantity of available work is staggering.

Fiber optic networks are being placed with the most cost effective trenchless technology method that can be used. This method has been dubbed “stitch boring” by its users. The method uses pneumatic impact moles to create small diameter bores between hand-excavated pits placed at approximately 40 foot intervals. An absolute minimum of equipment is brought on site, and it must all be light enough to be carried or wheeled about as progress is made.

After the bore is created, a number of fiber optic ducts, normally two to five, are pulled through the bore. The ducts, made of HDPE (high density polyethylene), are typically 1.66″ in outside diameter. A grouping or package of this many ducts requires a hole from 3.6 to 5.0 inches diameter. These sizes allow 0.5 inch of diametral clearance to reduce pulling friction. While the ducts are normally pulled in one at a time, the pulling resistance generated is still in excess of several hundred pounds force.

Larger bores with additional oversize will reduce the forces needed to pull the ducts through the bore. However the productivity, expense and handling difficulties caused by using a larger mole to create such a bore is not an acceptable tradeoff. Stitch boring operators would almost universally prefer small pneumatic impact moles, for example not exceeding 3 inches in diameter due to the light weight, ease of launching and ease of retrieval of such small diameter moles.

While the forces required to pull ducts for fiber optic cable are trivial if mobile equipment is employed, the desire to use the minimal amount of equipment in combination with low cost labor results in manual pulling of the ducts. Since the labor force must be ganged up to accomplish the duct pulling, focus is lost on digging and boring during the laborious process of towing the ducts through the bore, one duct at a time.

### SUMMARY OF THE INVENTION

In accordance with the invention, a cyclic cable pulling machine includes a reaction plate having a flat front face configured for engagement with a wall of a pit or hole and having a cable entry opening permitting a cable to pass through the reaction plate. The machine further includes and a cable pulling mechanism including a hydraulic cylinder and a cable gripping mechanism mounted on a frame secured to the reaction plate. The hydraulic cylinder reciprocates a cable gripping mechanism including a pair of jaws positioned to engage the cable during a pulling stroke. The hydraulic cylinder has one end in engagement with the reaction plate with the opposite end of the cylinder secured to the cable gripping mechanism for movement of the cable gripping mechanism away from the reaction plate during a pulling stroke of the machine. A powered clamping device attached to the frame holds the cable during return movement of the cable pulling mechanism toward the reaction plate for another pulling stroke. A sequencing valve is utilized to actuate the hydraulic cylinder of the cable pulling device and the clamping hydraulic cylinder according to a pulling cycle including a pulling stroke and retraction stroke.

In one variation, the powered clamping device includes a clamping hydraulic cylinder, a stationary jaw and a movable jaw. The cable is clamped between the moveable and stationary jaws when the clamping hydraulic cylinder is actuated to force the movable jaw toward the stationary jaw. Preferably, the clamping device is designed to permit slippage of the cable when an upper cable tension limit is reached.

In another aspect, the invention provides an apparatus for pulling a plurality of ducts through an underground bore. The apparatus includes a block including a conical nose section and a body having a plurality of outwardly opening, spaced apart pockets and a plurality of pipe pullers. The pipe pullers may be conical, carrot-type pullers having one or more exterior threaded surfaces designed to cut into the inside of a pipe when the puller is screwed into an end of the pipe. The pipe pullers are connected to the body with flexible connectors of substantially equal length having first and second ends, the second end of each of the pullers being sized to be trapped in one of the pockets. In one embodiment, the flexible connectors ane chains and the pockets are configured to receive and trap an endmost link of the chain in the pocket.

In yet another aspect the invention provides a method for installing an underground duct, comprising the steps of (1) placing an underground piercing tool in a launch pit, (2) operating the piercing tool to form a pilot bore from the launch pit to an exit pit, (3) feeding a cable through the pilot bore, (4) positioning a cyclic cable pulling machine in the exit pit and loading the cable into the machine, (5) pulling an expander attached to a trailing end of the cable through the pilot bore from the launch pit to the exit pit using the cyclic cable pulling machine to widen the pilot bore, and (6) installing one or more underground ducts in the widened pilot bore. Preferably, a plurality of ducts attached to the expander so that multiple ducts are pulled into the widened bore behind the expander as it is pulled through the earth. The piercing tool may be a pneumatic piercing tool which operates on compressed air fed through a hose trailing behind the tool, in which case the method further includes the steps of disconnecting the hose from the piercing tool when the pilot bore is completed, attaching the cable to the hose at the exit pit, and feeding the cable through the pilot bore by pulling the air hose back to the launch pit from the exit pit.

In one variation, the method includes the steps of (a) digging a series of first, second and third holes in the ground, (b) placing an underground piercing tool in the first hole, (c) operating the piercing tool to form a pilot bore from the first hole to the second hole, (d) then operating the piercing tool to extend the pilot bore from the second hole to the third hole, (e) feeding a cable through the pilot bore, (f) positioning a cyclic cable pulling machine in the second hole and loading the cable into the machine, (g) pulling an expander attached to a trailing end of the cable through the pilot bore from the first hole to the second hole using the cyclic cable pulling machine to widen the pilot bore, (h) moving the cyclic cable pulling machine from the second hole to the third hole and reloading the cable into it, (i) pulling the expander through the pilot bore from the second hole to the third hole using the cyclic cable pulling machine to widen the pilot bore; and (j) installing one or more ducts in the widened pilot bore, which ducts extend from the first hole through the second hole to the third hole. Preferably, the ducts are installed by attaching the attaching the ducts to the expander and pulling the ducts into the widened pilot bore behind the expander. In one variation, at least some of the holes are spaced apart by distances in the range of about 20 to 50 feet and may lie in a substantially straight line.

These and other aspects of the invention are further described in the detailed description which follows.

### BRIEF DESCRIPTION OF THE DRAWINGS

In the accompanying drawings, where like numerals denote like elements:

FIG. 1 is a schematic representation of an apparatus according to the invention being used for an underground multiple duct installation;

FIG. 2 is a perspective view of a reciprocating puller and duct pulling apparatus according to the invention;

FIG. 3 is a perspective view of the reciprocating puller of FIG. 2 in an extended position at the end of a pulling stroke;

FIG. 4 is a perspective view of the reciprocating puller of FIG. 2 in a retracted position at the end of a retraction stroke;

FIG. 5 is a top view of the reciprocating puller of FIG. 2;

FIG. 6 is a side view of the reciprocating puller of FIG. 2;

FIG. 7 is a bottom view of the reciprocating puller of FIG. 2;

FIG. 8 is a rear view of the reciprocating puller of FIG. 2;

FIG. 8 is a front view of the reciprocating puller of FIG. 2;

FIG. 10 is a perspective view of the pulling vise of the reciprocating puller of FIG. 2;

FIG. 11 is a exploded, partial perspective view of the pulling vise of the reciprocating puller of FIG. 2;

FIG. 12 is a perspective view of a vise jaw block of the pulling vise of FIG. 10;

FIG. 13 is a perspective view of the vise jaw block of FIG. 12 with the jaws positioned in the block;

FIG. 14 is a perspective view of the reciprocating puller of FIG. 2 taken from the opposite side;

FIG. 15 is an enlarged portion of FIG. 14 illustrating the secondary clamping device of the puller of FIG. 14;

FIG. 16 is a partial perspective view of the reciprocating puller of FIG. 14 with components omitted for clarity;

FIG. 17 is a side view of a duct pulling apparatus in accordance with the invention;

FIG. 18 is an exploded view of the duct pulling apparatus of FIG. 17;

FIG. 19 is a front view of the duct pulling apparatus of FIG. 17;

FIG. 20 is a sectional view of the duct pulling apparatus of FIG. 17 taken along line A-A of FIG. 19;

FIG. 21 is a perspective view of an alternative cable puller suitable for use in the practice of the invention;

FIG. 22 is a front end view of the cable puller of FIG. 21;

FIG. 23-24 are partial sectional views of the cable puller of FIG. 21 taken along line A-A of FIG. 22 showing the cable clamping mechanism of the puller in disengaged and fully engaged positions, respectively;

FIG. 25 is a partial sectional view of the cable puller of FIG. 21 taken along line A-A of FIG. 22 with the thrust cylinders in a fully extended position with the cable clamping mechanism in position to clamp the cable upon retraction of the thrust cylinders;

FIGS. 26-27 are partial views of the cable clamping mechanism of the cable puller of FIG. 21 in disengaged and fully engaged positions, respectively; and

FIG. 28 is a partial view of the cable clamping mechanism of the cable puller of FIG. 21 with the cable clamping mechanism in position to clamp the cable upon retraction of the thrust cylinders.

### DETAILED DESCRIPTION

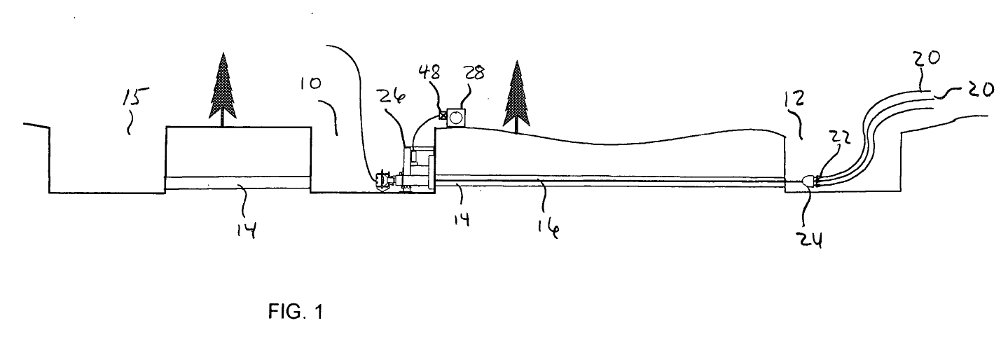

Turning to FIG. 1, a method for installing multiple underground ducts with a single pull generally includes the steps of digging shallow entrance and exit pits 10 and 12 and boring a pilot hole 14 from entrance pit 10 to exit pit 12 with a relatively small, for example 2.5 or 3 inch diameter mole. Directional boring apparatus for making such holes through soil are well known. The directional borer generally includes a series of drill rods joined end to end to form a drill string. The drill string is pushed or pulled through the soil by means of a device such as a hydraulic cylinder. See Malzahn U.S. Pat. Nos. 4,945,999 and 5,070,948, and Cherrington U.S. Pat. No. 4,697,775 (RE 33,793). After pilot hole 14 is completed, the mole is disconnected from the air feed hose in exit pit 12 and a flexible strand 16, typically a ½″ wire rope, is attached to the hose and drawn through the pilot hole as the air hose is removed. A duct puller 22 including conical expander 24 is attached to the end of strand 16 in exit pit 12. A plurality of ducts 20, typically high density polyethylene pipe (HDPE), are coupled to duct puller 22 using pipe pullers and flexible connectors such as chain or cable to connect the pipe pullers to expander 24.

A portable, lightweight cyclic cable pulling machine 26, powered with a portable hydraulic unit 28, is placed in entrance pit 10 and strand 16 is installed in the pulling machine. Cable pulling machine 26 is then actuated with a hydraulic control valve 48 to draw duct puller 22 and ducts 20 through pilot hole 14. When duct puller 22 emerges from pilot hole 14, cable puller 26 is disengaged from strand 16, moved to the next pit and the process repeated. In a typical stitch boring application where ducts are pulled between a series of pits 10, 12 the spacing between the pits will be on the order of about 20 to 50 feet.

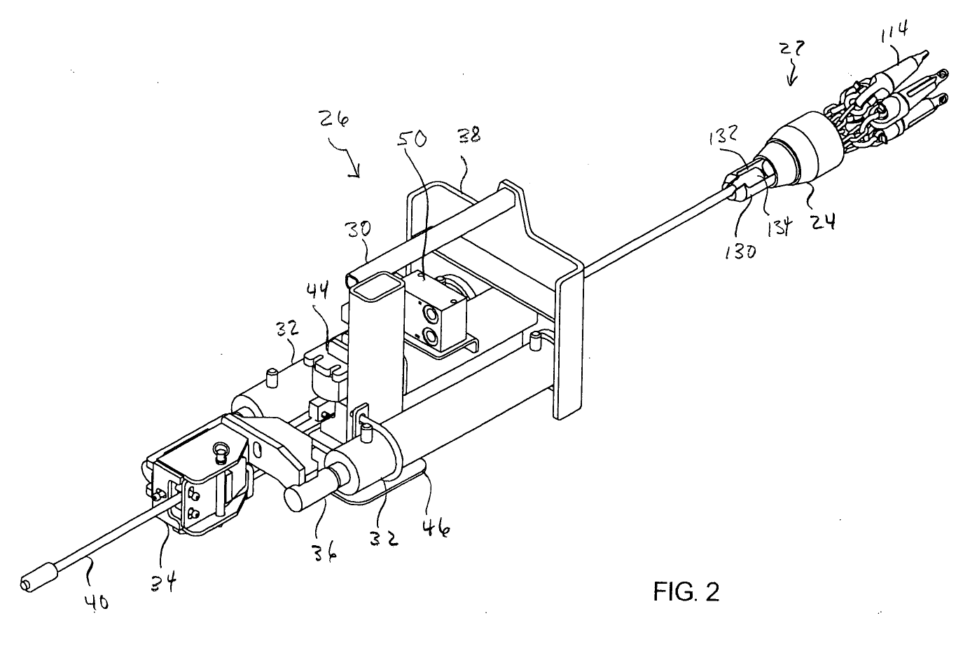

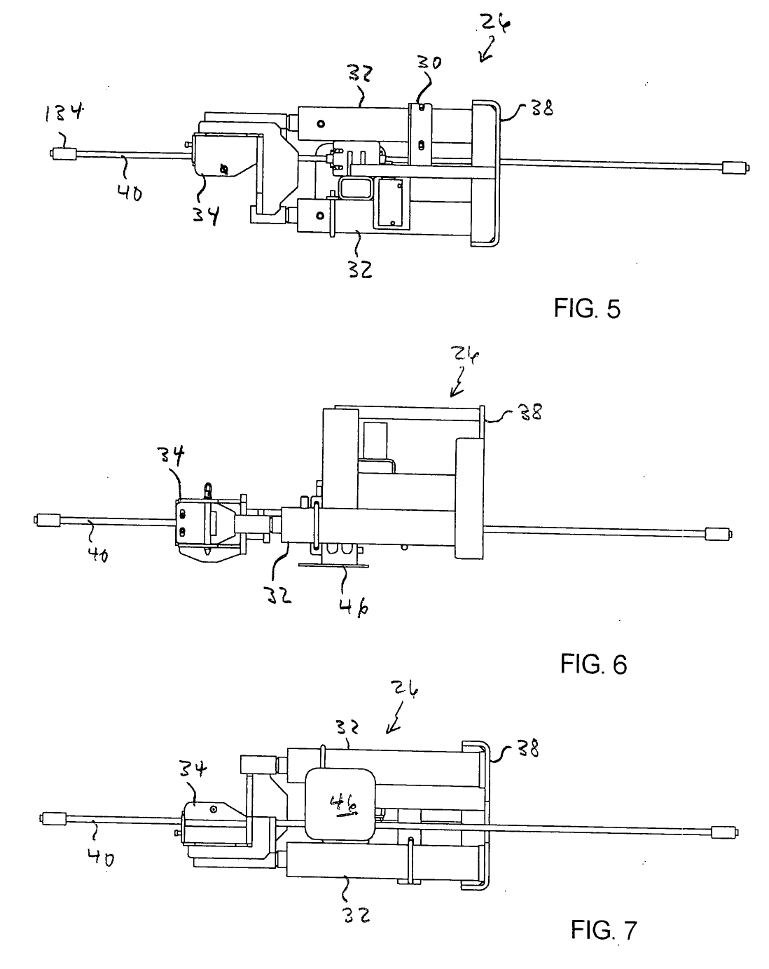

Turning to FIGS. 2-9 cyclic cable puller 26 includes a frame 30, a pair of thrust cylinders 32 mounted on the frame and a cable pulling vise 34 mounted on the ends of thrust cylinder rods 36. Vise 34 clamps cable 40 as thrust cylinders 32 are extended during the pulling stroke. An essentially flat reaction plate 38 mounted on the front of frame 30 abuts a side wall of a pit during operation. The base of each of thrust cylinders 32 engages reaction plate 38 such that reaction forces are transmitted through the reaction plate into the pit wall as the cylinders are extended. Since, as illustrated, cable 40 passes through reaction plate 38 below the center of the plate, pulling forces applied to the cable tend to generate or induce a twisting moment in puller 26. A stabilizer foot 46 extending from the bottom of frame 30 rests against the bottom of the pit and reacts against any such forces.

Duct puller 22 is attached to a distal end of cable 40 that passes through a cable slot 42 (FIG. 9) in reaction plate 38, through secondary clamping device 44 and pulling vise 34. Cable slot 42 has an open, slotted configuration to permit placement of the puller over cable 40, eliminating the need to thread the cable through puller 26. Cable slot 42 is sized to allow an operator to see the nose of expander 24 when it enters slot 42 and stop the pulling operation to avoid damage to cable puller 26 and/or duct puller 22.

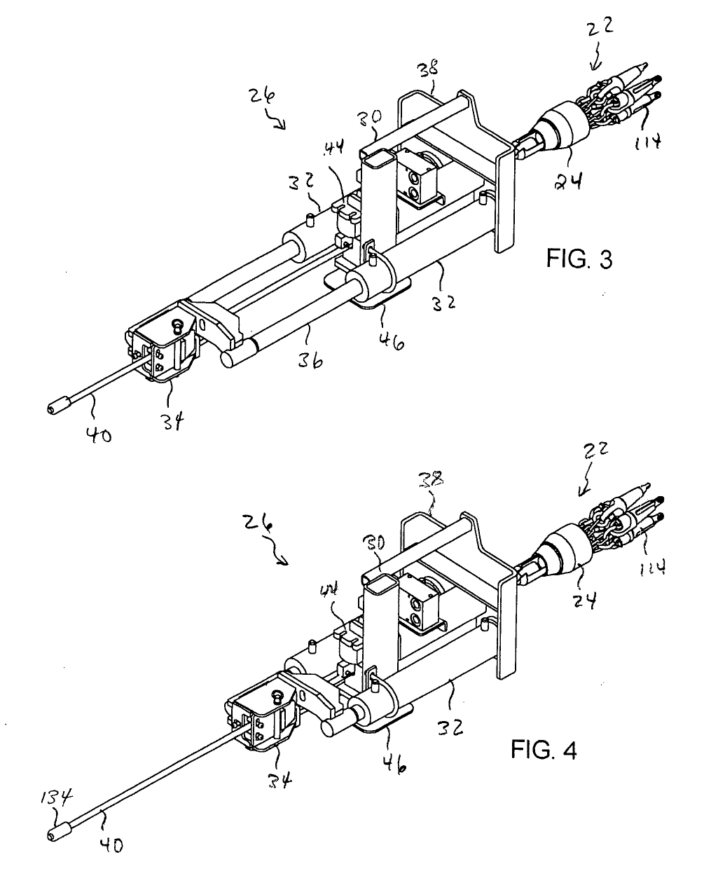

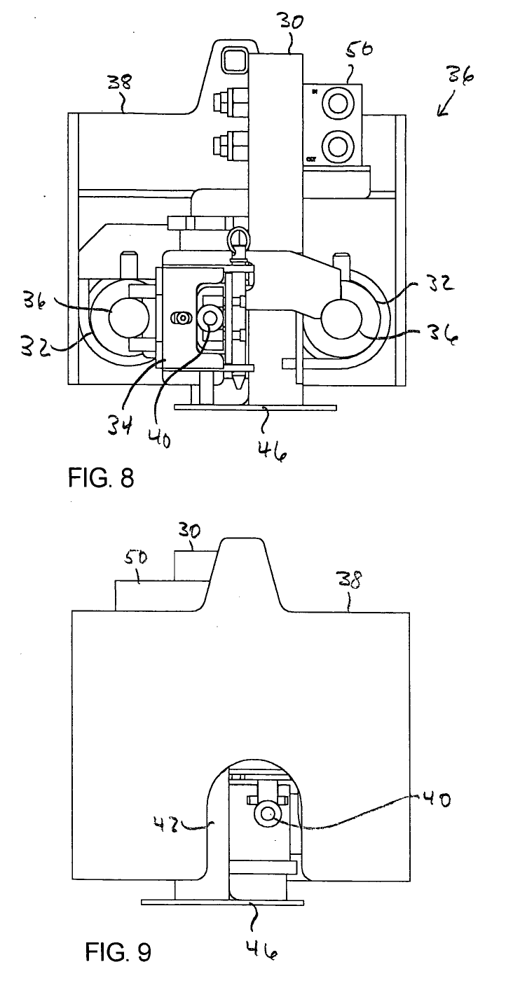

FIG. 2 illustrates cable puller 26 with cylinders 32 retracted. To initiate the pulling cycle, the operator utilizes a hydraulic spool valve 48 (FIG. 1) to supply pressurized hydraulic fluid to cylinders 32. As cylinder rods 36 extend, pulling vise 34 engages cable 40, pulling the cable and duct puller 22 through the ground. FIG. 3 illustrates puller 26 with thrust cylinders 32 fully extended. To retract thrust cylinders 32, the operator reverses spool valve 48, suppling pressurized fluid to a hydraulic sequencing valve 50 (FIG. 8) which actuates secondary clamping device 44 to clamp cable 40 in position. During the pulling operation, cable 40 tends to undergo elastic stretching. Secondary clamping device 34 clamps and holds cable 40 in position, preventing the cable from pulling back into the bore due to elastic recovery of the cable during the retraction stroke of cylinders 32.

After clamping device 44 has engaged cable 40, sequencing valve 50 supplies pressurized fluid to cylinders 32 to retract cylinder rods 36. As cylinder rods 36 retract, pulling vise 34 disengages from cable 40, allowing vise 34 to slide along cable 40 to the retracted position illustrated in FIG. 4. To repeat the cycle, the operator reverses spool valve 48, releasing clamping device 44 and extending cylinders 32.

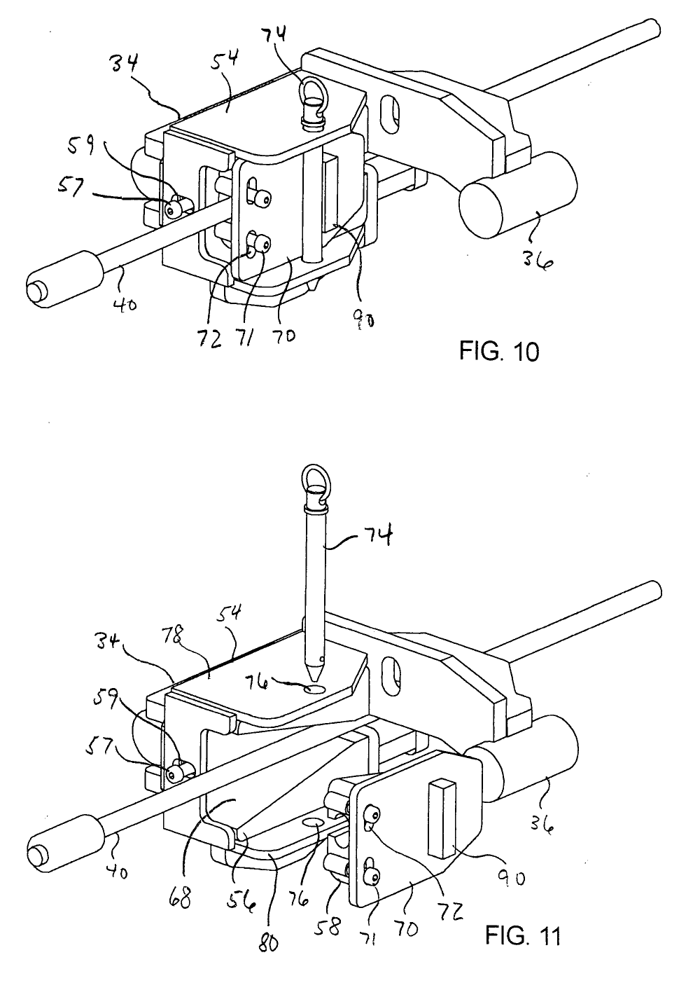

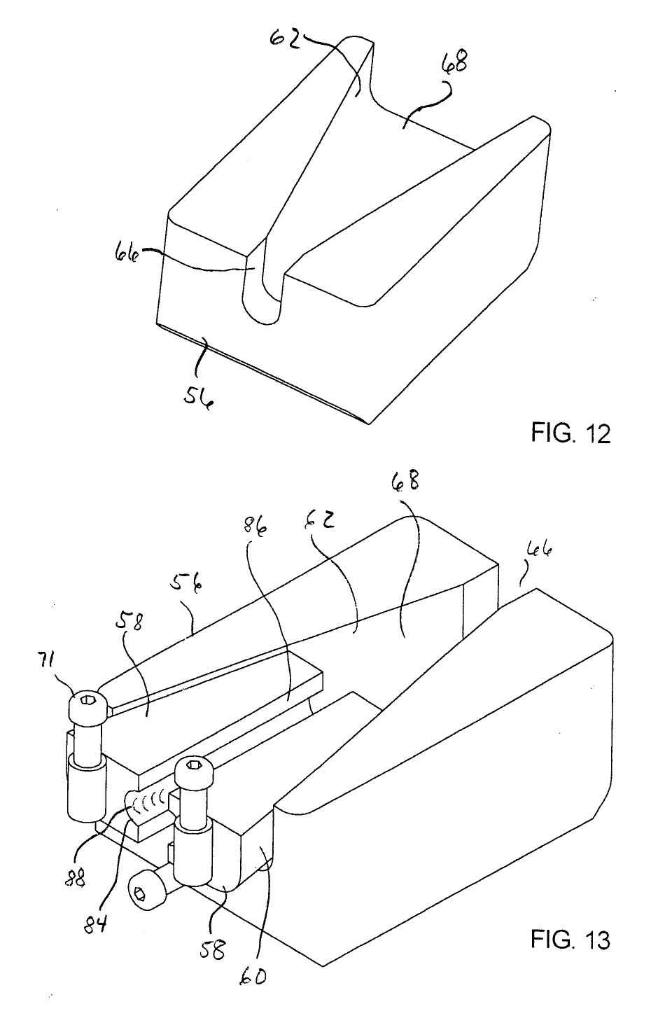

Turning to FIG. 10-13, pulling vise 34 includes a jaw frame 54, a jaw block 56 and a pair of opposed jaws 58. Jaws 58 are each formed with a tapered outside wall 60 configured for sliding engagement with tapered inside walls 62 of opening 68 formed in jaw block 56. Jaw block 56 is retained with block bolt 57 passing through slot 59 in frame 54. Jaw block 56 is formed with a cable slot 66 which allows cable 40 to pass through the jaw block and between jaws 58. Jaws 58 are mounted on a retainer plate 70 with jaw bolts 71 that pass through slots 72 formed in the plate, thereby allowing jaws 58 to move relative to each other. Semi-cylindrical recesses 84 formed on the inside walls 86 of each of jaws 58 are configured to receive cable 40. Serrations 88 formed on the surfaces of recesses 84 aid in gripping cable 40 between jaws 56 during the pulling operation.

Plate 70 is retained in jaw frame 54 with a retainer pin 74 that passes through holes 76 formed in upper and lower walls 78, 80 of frame 54. To place cable 40 in pulling vise 34, retainer plate 70 is detached from vise 34 by removing pin 74. Cable 40 is then fitted between jaws 58 and retainer plate 70 is reattached to vise 34. In this manner cable 40 may be connected to cyclic puller 26 without the need to thread the cable through the machine.

When thrust cylinders 32 begin to extend during the pulling stroke, frictional forces between cable 40 and jaws 58 pull the jaws inwardly into tapered opening 68 of jaw block 56, clamping the jaws together onto cable 40. Due to the tapered geometry of opening 68, jaws 58 are forced closer together as the pulling force on cable 40 is increased, increasing the clamping force applied to cable 40 by the jaws. With cable 40 clamped between jaws 58, the cable is pulled as cylinders 32 are extended. After cylinders 32 are fully extended, secondary clamping device 44 is actuated to hold cable 40 in place during the retraction stroke of cylinders 32. Then, as cylinders 32 begin to retract, friction between jaws 58 of pulling vise 34 and cable 40 pushes jaws 58 outwardly from tapered opening 68.

Outward movement of retainer plate 70 and jaws 58 is limited by a stop 90 welded or otherwise fastened to the outside wall of the retainer plate. Retaining pin 74 blocks further outward movement of plate 70 and jaws 58 when stop 90 engages retaining pin 74 at which time frictional forces between cable 40 and jaws 58 tend to force the jaws apart, releasing the cable as cylinders 32 are retracted. To effectively release jaws 58 in this manner, cable 40 is selected with sufficient stiffness to push jaws 50 outward without bending. With jaws 58 disengaged from cable 40, pulling vise 34 can slide freely along cable 40 during the retraction stroke of cylinders 32.

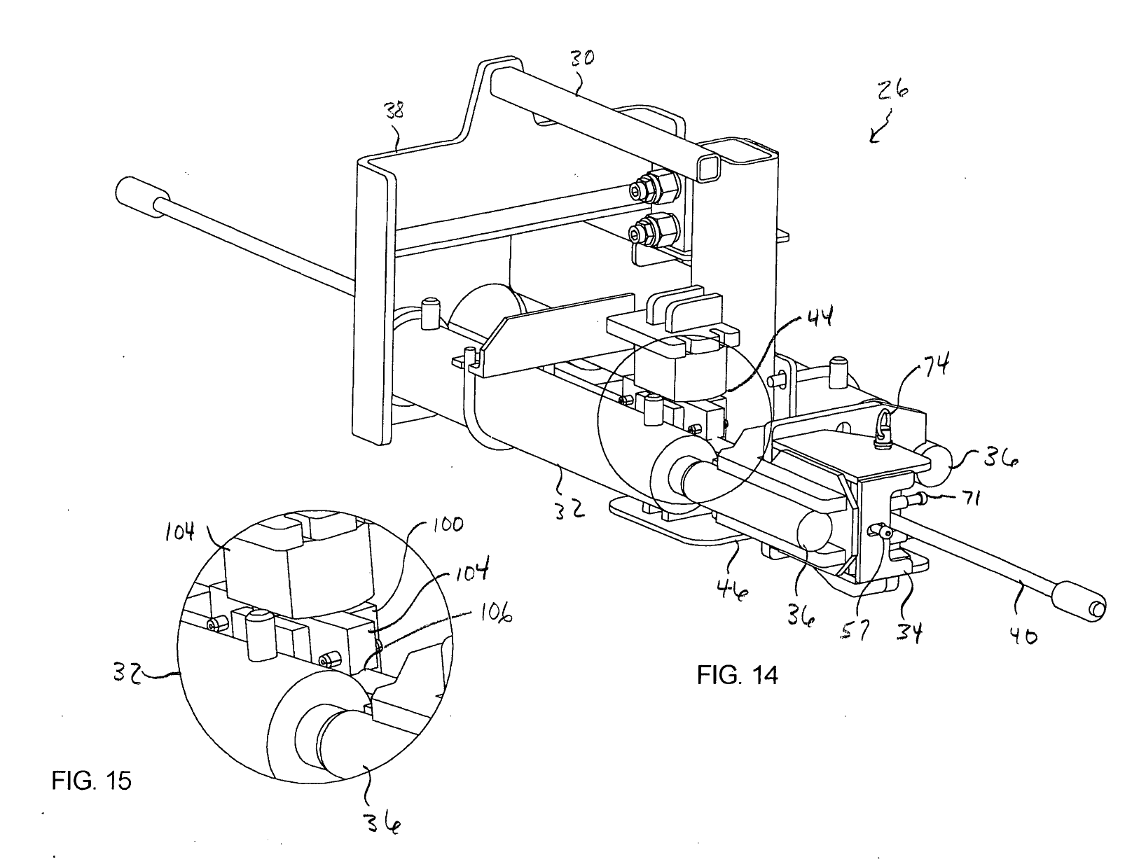

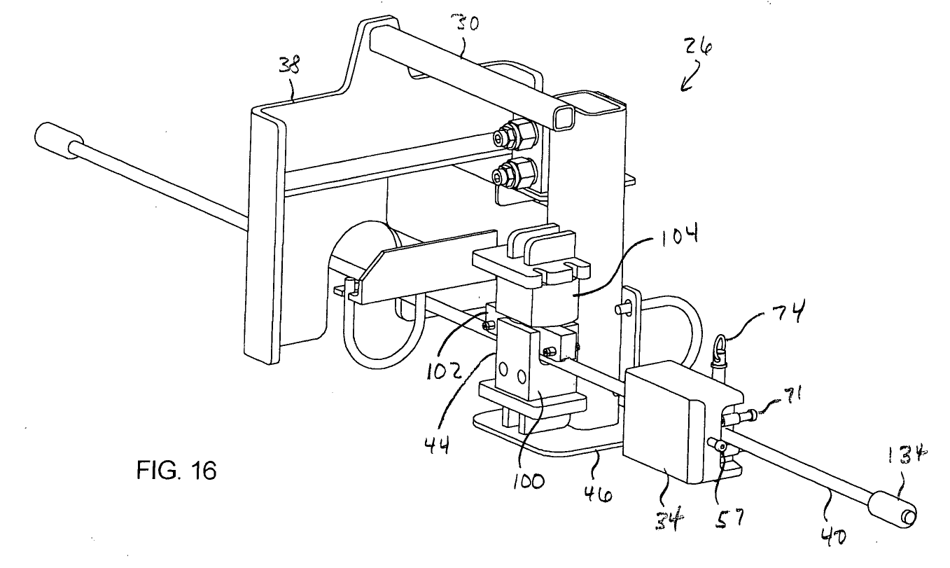

Referring to FIGS. 14-16, secondary clamping device 44 includes a vise block 100, a clamp jaw 102 and a clamp cylinder 104. When actuated, clamp cylinder 104 presses down on jaw 102, clamping cable 40 between the jaw and a stationary jaw or vise block 100. Clamp jaw 102 is formed with a recessed surface 106 to aid in securing cable 40 when cylinder 104 is actuated to clamp the jaw down on the cable. Clamp cylinder 104 is loosely held in place with bolts (not shown) such that the cylinder may be slipped out of the assembly. After cylinder 104 is slipped out of the assembly, clamp jaw 102 may be lifted and moved to the side, allowing cable 40 to be placed over vise block 100. Clamp jaw 102 is then positioned over cable 40 and clamp cylinder 104 replaced.

Secondary clamping device 44 is actuated by hydraulic sequencing valve 50 when the operator reverses spool valve 48 at the end of the pulling stroke to retract thrust cylinders 32 and pulling vise 34. Clamping device 44 holds cable 40 in place during the retraction stroke, enabling vise jaws 58 to disengage from the cable and allowing vise 34 to slide over the cable as cylinder 32 are retracted. Cable 40 is selected to be sufficiently stiff to avoid bending as vise jaws 58 disengage and pulling vise 34 slides over the cable.

Referring again to FIGS. 1 and 14-16, in some instances, the force required to pull cable 40 may be high and there may be significant elastic stretch in cable 40 after the pulling stroke, particularly where the distance between cyclic puller 26 and duct puller 22 is great. While secondary clamping device 44 applies sufficient clamp force to cable 40 to allow for breaking the grip of vise jaws 58 on the cable, the clamp force may or may not be high enough to maintain the elastic stretch of cable 40 after the pulling stroke. To prevent damage to cable 40 and cyclic puller 26, jaw 102 is designed to permit slippage of cable 40 in the reverse direction when high forces pulling forces due to elastic stretch of cable 40 are applied to clamping device 44.

In cases where the pulling force is high and the length of cable pulled is relatively long, cable slippage in the reverse direction can significantly reduce the length of cable that can be pulled per stroke. However, due to ease of transport and set up of puller 26 of the invention and since the distance between entry and exit pits 10 and 12 is typically on the order of forty feet, the need to pull long lengths of cable is reduced or eliminated. In the case of a cyclic cable puller with a 12 inch stroke placed in an exit pit 40 feet from the entrance pit, the unit would be stroked approximately 40 times. Further, cable 40 does need not be brought out of pit 10. Duct puller 22 may be pulled to the edge of pit 10, after which cyclic puller 26 is disconnected from cable 40. Cyclic puller 26 is then moved to the next pit, cable 40 is pulled through pilot hole 14 and re-connected to cyclic puller 26 after which duct puller 22 pulled to the next pit.

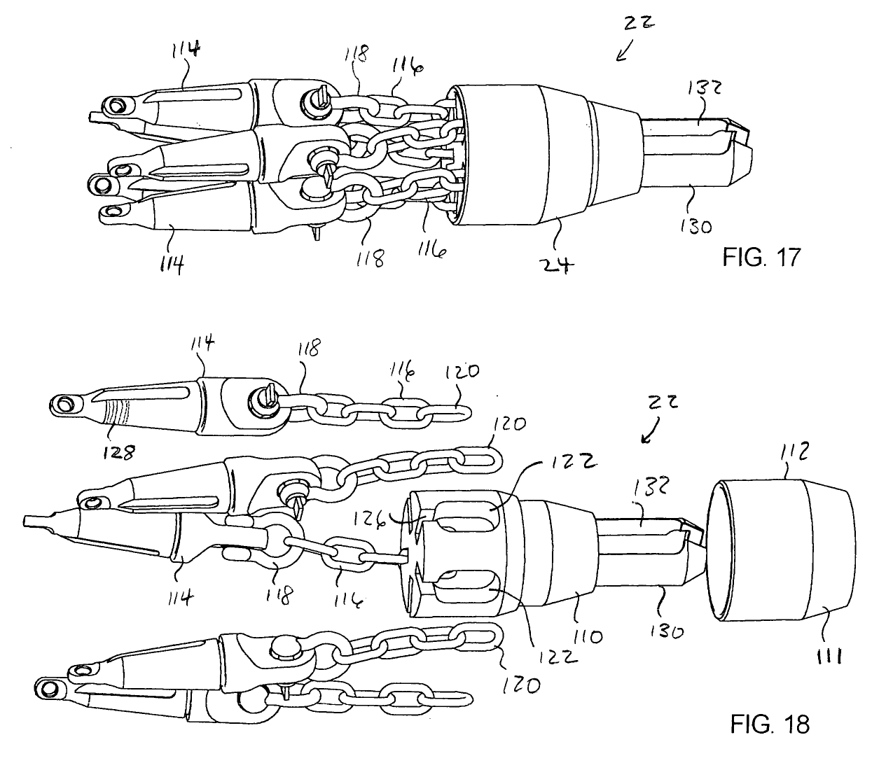

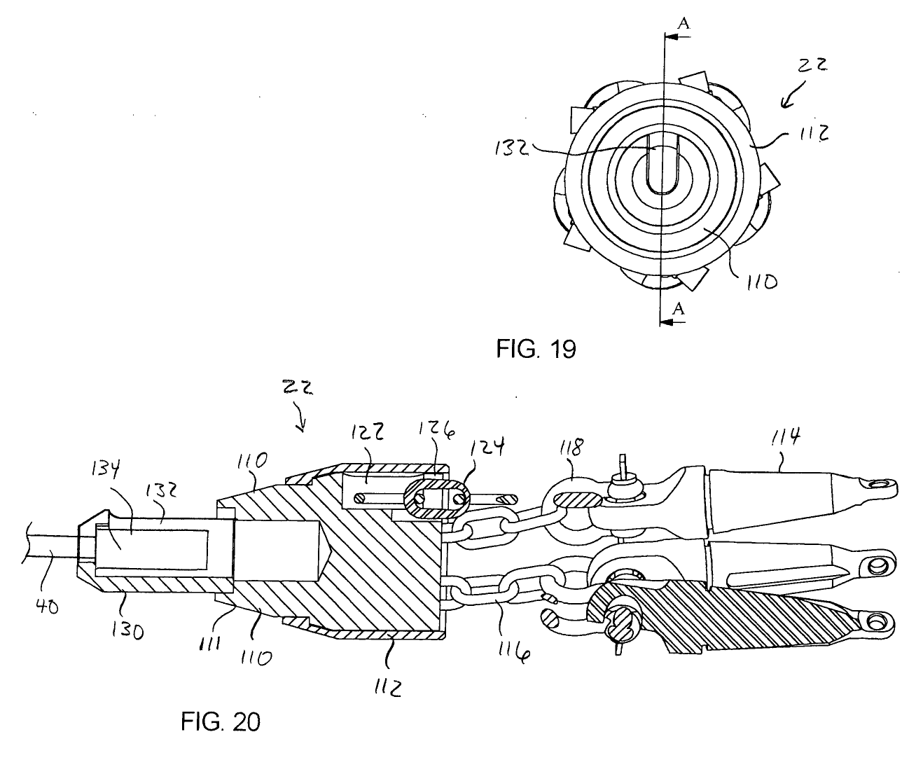

Turning to FIGS. 2 and 17-20, duct puller 22 includes an expander 24 having a block 110 with a conical front end 111, an expander sleeve 112 and a plurality of conical carrot-type pipe pullers 114. Carrot-type pullers 114 included exterior threads 128 and are connected to ducts 20 (FIG. 1), such as HDPE pipe, by screwing the puller into the end of a pipe. Threads 128 of puller 114 cut into the interior surface of the pipe when as the puller is screwed into the end of the pipe, permitting high towing loads to be applied to the pipe without separation from puller 114. A relatively short length of coil chain 116 with a shackle 118 is use to attach each of pullers 114 block 110. The last link 120 of the free end of each chain 116 is placed in a link pocket 122 formed in block 110 with the second to last link 124 fitted into and passing through link slot 126. In this manner, link 120 is trapped in pocket 122 such that carrot-type pullers 114 may be pulled through a bore behind block 110. In order to retain links 120 in pockets 112 during operations, sleeve 112 is fitted over block 110, covering and closing pockets 122. Other flexible connectors, such as a cable with a swaged end configured to fit into a pocket similar to link pocket 122, could be used in place of chain 116.

To connect duct puller 22 to cable 40, a slot-like pocket 132 is formed in the nose 130 of expander block 110. As best illustrated in FIG. 2, a button 134, swaged onto the distal end of cable 40, fits into pocket 132. When a pulling force is applied to cable 40, button 134 is trapped in pocket 132, enabling the cable to pull duct puller 22 and ducts 20 through a pilot hole or bore.

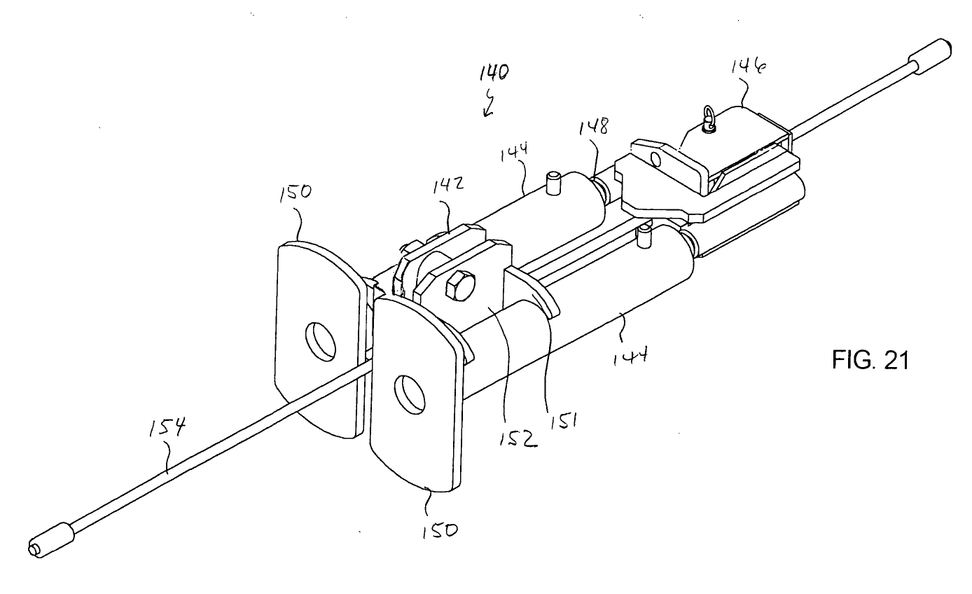

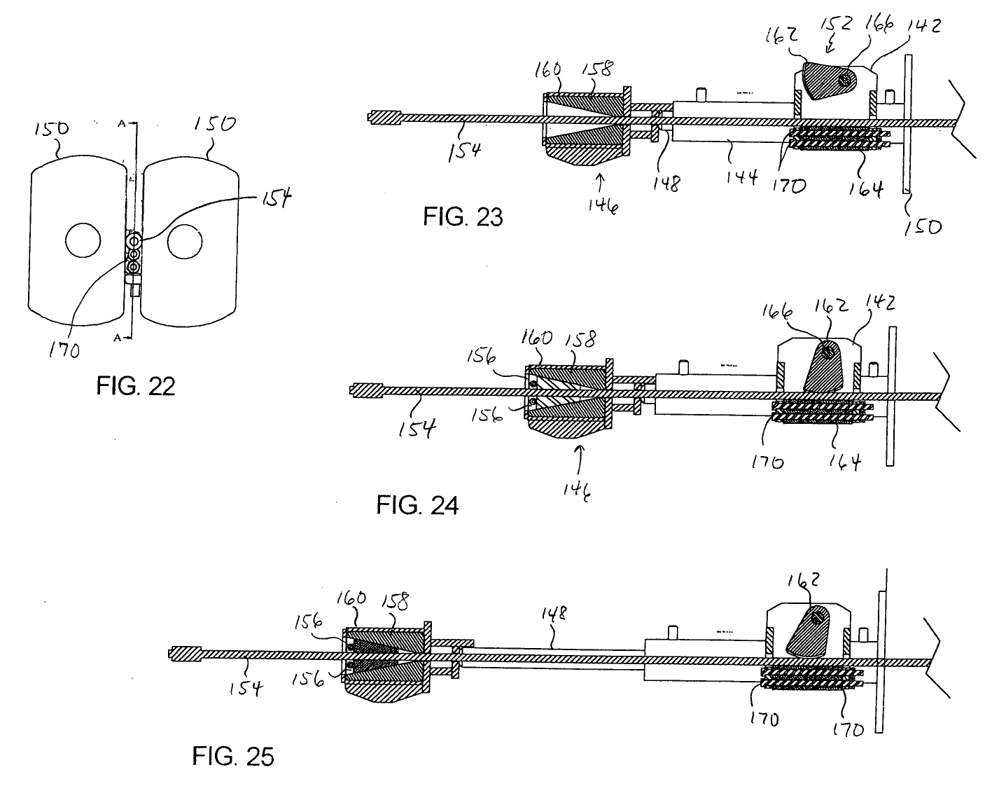

Turning to FIGS. 21-28, an alternate cable puller 140 includes a frame 142, a pair of thrust cylinders 144 and a cable pulling vise 146 mounted on the ends of rods 148 of the thrust cylinders. Thrust cylinders 144 are actuated to extend and retract with a hydraulic control valve such as spool valve 48 of FIG. 1. A pair of shore or reaction plates 150 mounted on the bases of thrust cylinders 144 are designed to be placed against the side will of the pit during operation. A cable clamping device 152 is mounted on the frame between thrust cylinders 144 to clamp cable 154 in position between pulling strokes. Cable clamping device 152 prevents cable 154 from being drawn back into the earth due to elastic recovery of the cable during retraction of cylinders 144.

Referring to FIGS. 23-25, pulling vise 146 is substantially identical to pulling vise 34 of cable puller 26 and includes a pair of opposed jaws 156 retained in a jaw block 158 for gripping cable 154 as the cable is pulled. Jaw block 158 and jaws 156 are mounted in a jaw frame 160 such that the jaws grasp cable 154 during the pulling stroke and release the cable during the retraction stroke as described in connection with pulling vise 34 of cable puller 26.

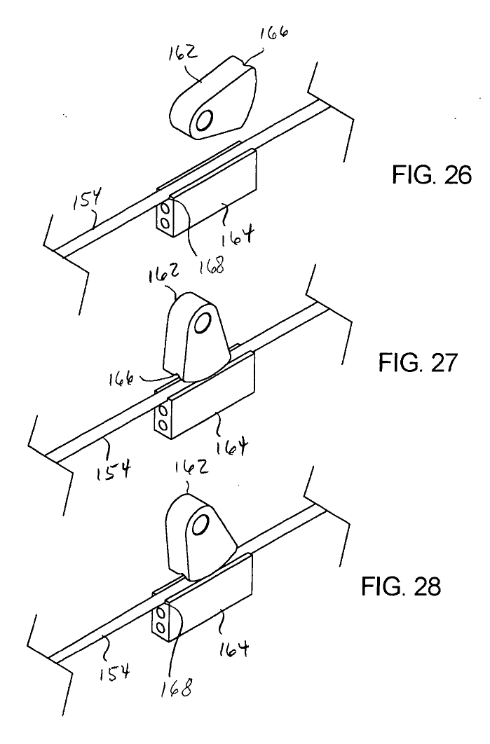

Cable clamping device 152 utilizes a pivoting shoe 162 to clamp cable 154 against a stationary cable block 164 between pulling strokes. Shoe 162 is mounted on a bolt or pin 166 that passes through frame 142 such that the shoe can pivot about the bolt to engage and release cable 154. Cable block 164 is secured to frame 142 with bolts 170. As best shown in FIGS. 26-28, shoe 162 and cable block 164 have grooved surfaces 166, 168 for engaging and clamping cable 154 therebetween. A pin 172 is provided to block shoe 162 in a raised, disengaged position as shown in FIGS. 23 and 26.

FIGS. 24 and 27 illustrate shoe 162 in the clamped position with thrust cylinders 144 in the retracted position prior to a pulling stroke. Upon initiation of a pulling stroke, shoe 162 pivots toward pulling vise 146, releasing cable as shown in FIGS. 25 and 28. When thrust cylinders 144 are retracted, frictional forces between shoe 162 and cable 154 causes shoe 162 to pivot to the position shown in FIGS. 24 and 27, clamping cable 154 against cable block 164 until the next pulling stroke is initiated.

The method and apparatus of the invention provides a number of significant advantages. Use of a light weight portable cable puller eliminates the need for crew members to gang up to pull the ducts though the bore. This allows the crew to stay on task digging additional pits and boring additional pilot holes. The light weight portable cable puller also permits the use of small diameter moles and permits installation of long continuous runs of duct.

While certain embodiments of the invention have been illustrated for the purposes of this disclosure, numerous changes in the method and apparatus of the invention presented herein may be made by those skilled in the art, such changes being embodied within the scope and spirit of the present invention as defined in the appended claims. For example, the apparatus and method of the invention may be used to install ducts in by pulling a pipe bursting tool through an existing pipeline with a plurality of ducts connected to the bursting tool. In this variation, a burst tool would be substituted for the expander or attached to the cable in from of the expander. In another variation, a cable could be plowed into the ground using a tractor mounted vibrating plow. The cable would then be exposed in pits and the cable puller and expander used to install ducts as described above.

1. A cyclic cable pulling machine, comprising:
a reaction plate having a flat front face configured for engagement with a wall of a hole and having a cable entry opening therein through the front face;
a frame secured to the reaction plate; and
a cable pulling mechanism including a hydraulic cylinder and a cable gripping mechanism, wherein the cable gripping mechanism has a pair of jaws positioned to engage the cable during a pulling stroke, and the hydraulic cylinder has one end portion in engagement with the reaction plate and has an opposite end portion secured to the cable gripping mechanism for movement of the cable gripping mechanism away from the reaction plate during a pulling stroke; and
a powered clamping device attached to the frame which holds the cable during return movement of the cable pulling mechanism toward the reaction plate for another pulling stroke.

2. The machine of claim 1, wherein the powered clamping device includes:
a clamping hydraulic cylinder;
a stationary jaw;
and a movable jaw movable toward the stationary jaw by the clamping hydraulic cylinder to clamp the cable between the stationary jaw and the movable jaw.

3. The machine of claim 2, further comprising a sequencing valve which actuates the hydraulic cylinder of the cable pulling device and the clamping hydraulic cylinder according to a pulling cycle.

4. The machine of claim 2, wherein the powered clamping device permits slippage of the cable when a upper cable tension limit is reached.

5. The machine of claim 1, further comprising means for disengaging the cable from the jaws during a return stroke of the cylinder.

6. An apparatus for pulling a plurality of ducts through an underground bore comprising:
a block including a nose section and a body, the body including a plurality of outwardly opening, spaced apart pockets;
a plurality of pipe pullers;
a plurality of flexible connectors for connecting the pipe pullers to the body such that the pipe pullers may be pulled through an underground bore behind the body, each of the flexible connectors having a first end attached to one of the pipe pullers and a second end configured to be trapped in one of the pockets; and
a retainer for retaining the second ends of the flexible connectors in the pockets.

7. The apparatus of claim 6 wherein the flexible connectors are chains and wherein the pockets are configured to trap the endmost link of the second end of the chain.

8. The apparatus of claim 6 wherein the retainer is a sleeve configured to fit over the expander block and pockets.

9. The apparatus of claim 6 wherein the pipe pullers comprise a conical body including a threaded exterior surface for engaging a pipe.

10. A method for installing an underground duct, comprising:
placing an underground piercing tool in a launch pit;
operating the piercing tool to form a pilot bore from the launch pit to an exit pit;
feeding a cable through the pilot bore;
positioning a cyclic cable pulling machine in the exit pit and loading the cable into the machine;
pulling an expander attached to a trailing end of the cable through the pilot bore from the launch pit to the exit pit using the cyclic cable pulling machine, thereby widening the pilot bore; and
installing one or more underground ducts in the widened pilot bore.

11. The method of claim 10, wherein the expander had a plurality of ducts attached thereto, such that the pilot bore is widened and multiple ducts are pulled into the widened bore behind the expander.

12. The method of claim 10, wherein the piercing tool is a pneumatic piercing tool which operates on compressed air fed through a hose trailing behind the tool, further comprising:
disconnecting the hose from the piercing tool when the pilot bore is completed;
attaching the cable to the hose at the exit pit; and
feeding the cable through the pilot bore by pulling the air hose back to the launch pit from the exit pit.

13. The method of claim 10, wherein the underground piercing tool has an outer diameter not exceeding 3 inches.

14. The method of claim 11 further comprising attaching each of the plurality of ducts to the expander with a flexible connector, the flexible connector having an end trapped in a pocket in the expander.

15. A method for installing an underground duct, comprising:
(a) digging a series of first, second and third holes in the ground;
(b) placing an underground piercing tool in the first hole;
(c) operating the piercing tool to form a pilot bore from the first hole to the second hole;
(d) then operating the piercing tool to extend the pilot bore from the second hole to the third hole;
(e) feeding a cable through the pilot bore;
(f) positioning a cyclic cable pulling machine in the second hole and loading the cable into the machine;
(g) pulling an expander attached to a trailing end of the cable through the pilot bore from the first hole to the second hole using the cyclic cable pulling machine, thereby widening the pilot bore;
(h) moving the cyclic cable pulling machine from the second hole to the third hole and reloading the cable into it;
(i) pulling the expander through the pilot bore from the second hole to the third hole using the cyclic cable pulling machine, thereby widening the pilot bore; and
(j) installing one or more ducts in the widened pilot bore, which ducts extend from the first hole through the second hole to the third hole.

16. The method of claim 15, wherein step (j) comprises attaching the ducts to the expander and pulling the ducts into the widened pilot bore behind the expander.

17. The method of claim 15, wherein at least some of the holes are spaced apart by distances in the range of about 20 to 50 feet.

18. The method of claim 15, wherein at least three of the holes are spaced apart by distances in the range of about 20 to 50 feet and lie substantially in a straight line.
